(19) United States
(12) Patent Application Publication
(10) Pub. No.: US 2023/0288089 A1
(43) Pub. Date: Sep. 14, 2023

(54) METHOD AND SYSTEM FOR CONTROLLING BUILDING ENVIRONMENTAL CONTROL SYSTEM

(71) Applicant: Palo Alto Research Center Incorporated, Palo Alto, CA (US)

(72) Inventors: Warren Jackson, San Francisco, CA (US); Saman Mostafavi, San Francisco, CA (US); David Eric Schwartz, Concord, MA (US); Eric Allan Bier, Palo Alto, CA (US); Paloma Juanita Fautley, San Jose, CA (US); Eric David Cocker, Redwood City, CA (US)

(21) Appl. No.: 17/654,210

(22) Filed: Mar. 9, 2022

(51) Int. Cl. F24F 11/63

(52) U.S. Cl. CPC F24F 11/63; F24F 2110/10

(57) ABSTRACT

A heating, ventilation, and air conditioning (HVAC) control system is provided. The system includes one or more sources of controlled air, a network of portable sensors that are configured to measure one or more parameters of an environment, one or more environmental condition controllers that are configured to operate the one or more sources of controlled air, and a computing device, including a processor and memory. The memory stores programming instructions that are configured to, when executed, cause the processor to generate an initial lumped-element model of the environment, update the initial lumped-element model using the one or more parameters of the environment to generate an adapted lumped-element model of the environment, and cause the one or more environmental condition controllers to adjust an output of the one or more sources of controlled air based on the adapted lumped-element model.

### BACKGROUND

The present disclosure relates to heating, ventilation, and air conditioning (HVAC) systems and, in particular, to HVAC systems incorporating interconnected hardware configured to adapt to changing environments.

Maintaining and adjusting building HVAC systems is an important component of energy conservation, building functionality, and maintaining the health and comfort of those within the building. Due to the complex and varying designs of buildings, HVAC control needs can vary from building to building. For optimal control of HVAC systems, models which take into account various unique aspects of each building can result in up to a 30% or more reduction in energy costs while maintaining the health and comfort of those within the building.

Implementing these models comes at the cost of many parameters describing the building's comfort response. The parameters affecting comfort include, for example, air temperature, humidity, and air flow. These factors, in turn, are affected by building characteristics, which include, for example, a building's shape, location, number and position of windows, number, position, and dimensions of rooms, and access to sunlight, among other factors. These factors can also be affected by, for example, objects within each room in the building, structures within the building, the heat flow between rooms and with the outside and ground, and the heat load imposed by the occupants and solar insolation. Similarly, humidity is affected by HVAC air flow, mixing ratios of inside and outside air, and water retention properties of room surfaces, and air flow is adjusted by actuators such as, for example, fans, thermal gradients, and connections such as doors and windows between rooms and to the outside. These parameters can be estimated or measured or computed. Often, the parameters include (1) the thermal mass and water retention of the air, the objects, and the surfaces of the room, (2) the interchange of heat, air, and moisture between rooms, the ground, and the outside, (3) the heat, air, and humidity load of the building which is comprised of solar insolation, equipment within the building, and occupants, and (4) the position, capabilities, and sensitivity of the building sensors/HVAC components involved in sensing and effecting the state of the building.

Estimation or computation of these parameters is difficult due to small, hidden changes in structures and materials that can result in a large change in the comfort response. Additionally, measurement of the parameters is very labor intensive, and the ability to create large, inexpensive networks of sensors/actuators necessary for model parameter estimation has been limited in the past.

Computing the properties from the components can be accomplished by making models using the components and the properties of the component materials. For example, thermal properties of a wall can be estimated from the area and R-value of the wall components. However, small changes in the wall structure can change the thermal properties significantly. It is difficult to take into consideration all the important parameters. Moreover, it is a complex problem to account for the effect of all components such as, for example, curtains, furniture, rugs, etc., and various air flows which contribute to perceived comfort.

In general, excluding pathological models, the number of actuators, sensors, and unique (orthogonal) system excitations should be roughly comparable (in a same order of magnitude) as the number of parameters in the model. Additionally, one may have to cycle through several model construction/system identification (ID) cycles to converge on an adequate model.

It is also noted that, just because the parameters of the model fit the existing data, it does not mean that the model parameters are the best fit for new data and, particularly, for extrapolation to new regions of the data space. Alternatively, many of these parameters can be measured with sensors and actuators. If the outside temperature changes, the flow of heat into a room can be estimated by the rise in temperature within the room, and the resulting resistance can be determined by the ratio of heat flow to temperature rise. Unfortunately, most buildings do not have enough sensors or actuators to uniquely determine the parameters to a necessary degree of accuracy. Additionally, the response of a room to an influx of heat is determined not only by the thermal mass of the air of the room, but also by the response of the surfaces of the room to the temperature rise, while most sensors just measure the temperature rise of the air and not the surface response. The surface response is particularly important for solar insolation falling on a surface. Furthermore, full characterization of the HVAC comfort depends not only on the temperature of the air but also on flow and moisture volumes.

For at least these reasons, systems and methods for controlling an HVAC system while dynamically adapting to changing conditions are needed.

### SUMMARY

According to an aspect of the present disclosure, a heating, ventilation, and air conditioning (HVAC) control system is provided. The system includes one or more sources of controlled air, a network of portable sensors that are configured to measure one or more parameters of an environment, one or more environmental condition controllers that are configured to operate the one or more sources of controlled air, and a computing device, including a processor and memory. The memory stores programming instructions that are configured to, when executed, cause the processor to generate an initial lumped-element model of the environment, update the initial lumped-element model using the one or more parameters of the environment to generate an adapted lumped-element model of the environment, and cause the one or more environmental condition controllers to adjust an output of the one or more sources of controlled air based on the adapted lumped-element model.

According to various embodiments, one or more of the portable sensors may be configured to be repositioned to a new location within the environment prior to measuring one or more subsequent parameters of the environment.

According to various embodiments, the programming instructions may be configured to further cause the processor to update the adapted lumped-element model using the one or more subsequent parameters of the environment to generate an updated adapted lumped-element model of the environment.

According to various embodiments, the portable sensors may include one or more of the following: air temperature measurement sensors; humidity sensors; surface temperature measurements; infrared remote surface measurement sensors; air flow measurement sensors; light sensors; or sensors for generating geometric measurements.

According to various embodiments, one or more of the portable sensors may be positioned outside the environment.

According to various embodiments, the environment may include a building and/or one or more rooms within the building.

According to various embodiments, adjusting the output may include increasing or decreasing a temperature of the environment.

According to various embodiments, adjusting the output may include adjusting a humidity of the environment.

According to various embodiments, the computing device may further include a user interface configured to receive one or more initial parameters of the environment.

According to various embodiments, the programming instructions may be configured to further cause the processor to generate the initial lumped-element model based on the one or more initial parameters of the environment.

According to another aspect of the present disclosure, a method for controlling an HVAC system is provided. The method includes generating, using a processor of a computing device, an initial lumped-element model of an environment, positioning portable sensors relative to the environment, the portable sensors being in a network of sensors, measuring, using the portable sensors, one or more parameters of an environment, updating the initial lumped-element model using the one or more parameters of the environment, generating an adapted lumped-element model of the environment, and adjusting, using one or more environmental condition controllers, an output of one or more sources of controlled air based on the adapted lumped-element model. The one or more environmental condition controllers are configured to operate the one or more sources of controlled air.

According to various embodiments, the method may further include repositioning one or more of the portable sensors to a new location relative to the environment, and measuring one or more subsequent parameters of the environment using the repositioned portable sensors.

According to various embodiments, the method may further include updating the adapted lumped-element model using the one or more subsequent parameters of the environment, and generating an updated adapted lumped-element model of the environment.

According to various embodiments, one or more of the portable sensors may be positioned outside the environment.

According to various embodiments, adjusting the output may include increasing or decreasing a temperature of the environment.

According to various embodiments, the computing device may include a user interface configured to receive one or more initial parameters of the environment, and the method may further include inputting the one or more initial parameters of the environment into the computing device via the user interface.

According to various embodiments, the initial lumped-element model may be based on the one or more initial parameters of the environment.

According to yet another aspect of the present disclosure, a computer-readable medium comprising programming instructions is provided. The programming instructions are configured to cause a processor to generate an initial lumped-element model of an environment and update the initial lumped-element model using one or more parameters of the environment, generating an adapted lumped-element model of the environment. The one or more parameters are measured using portable sensors in a network of sensors positioned relative to the environment. The programming instructions are further configured to adjust, using one or more environmental condition controllers, an output of one or more sources of controlled air based on the adapted lumped-element model. The one or more environmental condition controllers are configured to operate the one or more sources of controlled air.

According to various embodiments, the portable sensors may be configured to be repositioned to a new location relative to the environment and measure one or more subsequent parameters of the environment at the new location, and the programming instructions may be further configured to cause the processor to update the adapted lumped-element model using the one or more subsequent parameters of the environment, and also to generate an updated adapted lumped-element model of the environment.

According to various embodiments, the initial lumped-element model may be based on one or more initial parameters of the environment.

### BRIEF DESCRIPTION OF THE DRAWINGS

FIG. 1 is an example of a heating, ventilation, and air conditioning (HVAC) control system, in accordance with various embodiments of the present disclosure.

FIG. 2 is an adaptive control workflow for controlling an HVAC system, in accordance with various embodiments of the present disclosure.

FIG. 3 is flow chart depicting a method for controlling an HVAC system, in accordance with various embodiments of the present disclosure.

FIG. 4 illustrates a block diagram of example hardware that may be used to contain or implement program instructions according to an embodiment.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. When used in this document, the term “comprising” (or “comprises”) means “including (or includes), but not limited to.”

In this document, the term “approximately,” when used in connection with a numeric value, is intended to include values that are close to, but not exactly, the number. For example, in some embodiments, the term “approximately” may include values that are within +/−10 percent of the value.

Other terms that are relevant to this disclosure are defined at the end of this Detailed Description section.

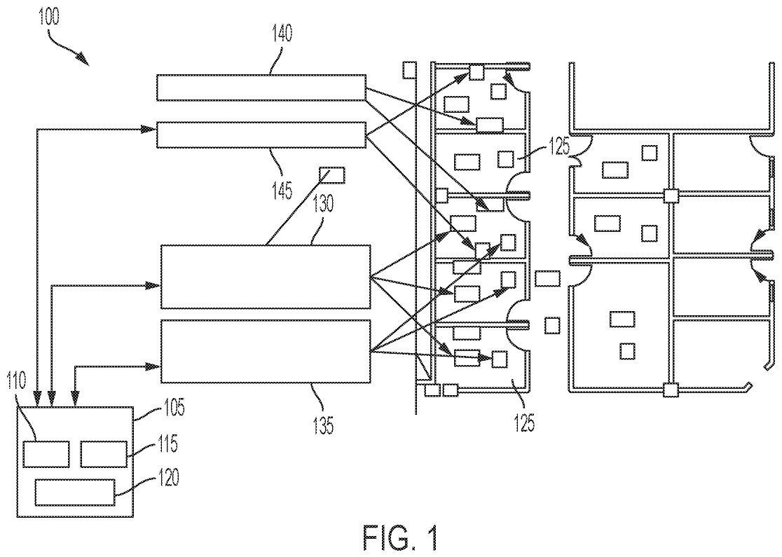

Referring now to FIG. 1, a heating, ventilation, and air conditioning (HVAC) control system 100 is illustratively depicted, in accordance with various embodiments of the present disclosure. This term will use the phrase “heating, ventilation, and air conditioning” and the acronym to cover a system that provides any or all of the functions (heating, ventilation, or air conditioning) including, as is appropriate for the context, systems that provide all three of the functions, only two of the functions, or only one of the functions.

Buildings are not all constructed according to singular plan or model. Nor are they all constructed from the same materials. Both individual rooms and buildings as a whole are generally unique in their material construction, shape and design, and position and orientation in relation to the sun and other outside environmental influences (if any). Factors which affect the environmental influences on a building structure include, but are not limited to, the time of year, the geographic location and orientation of the building, the elevation of the building, the building materials used in the construction of the building, and the location, dimensions, and features of any neighboring structures. Additionally, buildings, whether as a whole or in part (e.g., individual rooms within the building), are typically not permanent in their design and function or, in the event of remodeling, their dimensions. Objects, such as furniture, are often moved, and doors and windows are often opened and closed, sometimes multiple times a day. These changes often happen many times over the lifespan of a building, and each of these changes can affect the temperature and ventilation of a building, room, or series of rooms. Because of this, a standardized HVAC control model would likely not be the most efficient model for adjusting the temperature and ventilation of a building or a room. Rather, a specialized HVAC control model based on, for example, the shape, materials, and/or position of an structure (e.g., building, room, hall, etc.), as well dynamic features such as, for example, the opening and closing of doors and/or windows or the moving/rearranging of furniture and/or other relevant items, would be more efficient for adjusting the temperature and ventilation for a given environment.

According to various embodiments, the system 100 is configured for the development and parameter determination of rapid, low cost, and complete HVAC models for optimal building control. The system 100 incorporates hardware, communication channels, and machine learning in both modeling and in adjusting the temperature and ventilation for a given environment. In particular, portable actuators and sensors can be used along with permanent sensors and actuators to determine relevant model parameters.

According to various embodiments, the system 100 includes one or more computing devices 105. The computing devices include computer memory 110 and one or more processors 115. The computing device may include a user interface 120 (e.g., a keyboard, touchscreen, voice command, etc.). According to various embodiments, the environment 125 (e.g., a building, room, hall, etc.), over which the HVAC control system 100 monitors and regulates, is determined by generating a series of geometric and/or functional data points pertaining to various factors of the environment, such as those described above. These data point may be automatically generated using data from one or more sensing devices (e.g., spatial sensors incorporating camera imagery, LiDAR, and/or other suitable spatial sensing technology or technologies), manually entered into the system 100 via the user interface 120, and/or by other suitable means. Once the geometric and/or functional data points are determined for the environment 125, the data points are entered (e.g., manually or uploaded) into the computing device. The geometric and/or functional data points correlate to initial parameter data of the environment 125. According to various embodiments, the system 100 obtains the geometric and/or functional data points via blueprint analyzation, robot simultaneous localization and mapping (SLAM), environment walkthrough, previous system documentation, IR imaging, and/or other suitable means. According to various embodiments, the geometric and/or functional data points may include, e.g., the thermal mass of the air within the environment, data points pertaining to any objects within the environment (e.g., size, shape, material construction, etc.), measurements of the surfaces of the environment, the interchange of heat between rooms, the ground, and the outside, the heat load of a building or room (taking into account solar and/or other insolation, equipment, and occupants), and the position, capabilities, and sensitivity of the building and/or room sensors/HVAC components involved in sensing and effecting the state of the environment.

Once the geometric and/or functional data points are entered into the computing device 105, the system 100 generates an initial draft version of an HVAC control lumped-element model. A lumped-element model can be used to simplify and control a complex system. According to various embodiments, an HVAC system may include a number of distinct functional components (e.g., all heat, air, and/or moisture transfer mechanisms). Using a lumped-element model, the behavior of each of these functional components can be simplified to distinct entities (lumped-elements) that approximate the behavior of each of the functional components under certain conditions and situations. By approximating each of the functional components as simplified entities, the collection of functional components that make up the HVAC system can be simplified, enabling a model (a lumped-element model) to be generated for controlling all of the functional components of the HVAC system based on these approximations.

According to various embodiments, in the HVAC control lumped-element model, all of the heat, air, and/or moisture transfer mechanisms (e.g., from object-to-object, object-to-room, room-to-object, room-to-room, etc.) are linearized, and the model can be used for evaluating energy efficiency and simulating functional parameters of the HVAC system. According to various embodiments, a building can be treated as a singular zone or divided into a plurality of zones. For example, an HVAC control lumped-element model may be generated for one more distinct areas (e.g., rooms, halls, wings, etc.) of a building in which heating and cooling can be controlled. Each of these areas would function as a zone for the HVAC control lumped-element model.

In order to more efficiently control the temperature and ventilation of an environment, one or more sensors can be placed within the environment. The sensors can be used to collect data pertaining to the environment. The system 100 may then use this data to update the HVAC control lumped-element model. The initial draft version of the HVAC control lumped-element model can be used to determine the placement and location of various sensors 130, environmental condition controllers 135, fixed HVAC components 140, and/or permanent building sensors 145 within the environment 125. Sensors 130 and/or environmental condition controllers 135 may include portable and/or fixed components. According to various embodiments, the portable components can be used during a modeling model discovery phase, during which the parameters of the lumped-element model are determined and removed once the model is sufficiently accurate.

The sensors 130, environmental condition controllers 135, and/or HVAC components 140 are positioned within various locations within the environment 125 (e.g., they may be placed in a plurality of rooms within a building) and form a network which is interconnected by suitable means such as, for example, radiofrequency (RF) waves, WiFi, Bluetooth, and/or other suitable interconnectivity means. According to various embodiments, the environmental condition controllers 135 may include, for example, portable devices such as local space heaters, fans, small air conditioning units, and/or other suitable environmental condition controllers. In some embodiments, no additional heating and/or cooling hardware is added and, instead, the building's existing fixed air conditioning and/or heating system components are used to provide controlled thermal variations. The response of these fixed components can be modified and interconnected to the network. Examples of modifying an existing system to give it more centrally controlled actuators include the incorporation of computer-controlled drapes or retrofitted computer controlled heater duct air flow controllers. For example, the environmental condition controllers 135 can be configured to enable the computer-controlled drapes to be opened and/or closed, based on determined needs of the system 100. Various sensors may also be added to an existing structure, as well. In other embodiments, both fixed and portable heating and/or cooling hardware are used. According to various embodiments, the HVAC control system 100 includes networked actuator and sensor capabilities which can be added, removed, and/or relocated within the structure or, if fixed, the responses of the actuators and sensors can be modified and their capabilities can be controlled and sensed remotely.

According to various embodiments, the sensors 130 include, for example, air temperature measurement sensors (e.g., thermometers), infrared (IR) remote surface measurement sensors, air flow measurement sensors (e.g., in HVAC ducts), light sensors (e.g., for sensing and measuring solar energy), sensors for generating geometric measurements of dimensions of various buildings, rooms, etc. within a building (e.g., camera imaging sensors, LiDAR sensors, etc.), and/or other suitable sensors. One or more of the sensors 130 (e.g., the IR sensor(s)) are configured to detect where heat is entering and/or escaping from the environment and/or neighboring regions. According to various embodiments, sensors may be added and utilized and/or existing sensors within the environment may be utilized.

During the modeling model discovery phase, in order to determine the parameters of the lumped-element model, various time-dependent actuations are applied to the environmental condition controllers 135. The resulting response is used to determine the parameters of the lumped-element model. The time-dependent actuations, for example, can include, but are not limited to, step functions, ramps, sine waves, and pulses. An example process by which a system may use changes induced by heat sources to determine parameters is shown in Table 1. Similar equations hold for humidity and air flow where the temperature is replaced by the concentration of water vapor present in the air in the room (measured, e.g., by a suitable humidity sensor), the heat flow is replaced by water added or removed by air flow, and the source/sink terms represent sources/sinks for air moisture. Air flow can be represented by pressure replacing the temperature, air flow replacing the heat flow, and source and sinks representing HVAC system ducts supplying air and removing air from the room. Similar equations can apply to other variables.

TABLE 1
$\frac{d}{d t} {T}_{i} := {\sum }_{j = neighbor}^{N} \frac{1}{{C}_{i} \cdot {R}_{i j}} \cdot ( {T}_{j} - {T}_{i} ) + \frac{{F}_{i}}{{C}_{i}}$
For steady state $\frac{d}{d t} {T}_{i} := 0 {T}_{j} := {T}_{j}^{e q}$

| | |
|---|---|
| $0 := {\sum }_{j = n e ighbor}^{N} \frac{1}{{C}_{i} \cdot {R}_{i j}} \cdot ( {T}_{j}^{e q} - {T}_{i}^{e q} ) + \frac{{F}_{i}}{{C}_{i}}$ | Equation (1) |
| Then with | |
| $Δ {T}_{i} := {T}_{i} - {T}_{i}^{e q}$ $\frac{d}{d t} Δ {T}_{i} := {\sum }_{j = n e ighbor}^{N} \frac{1}{{C}_{i} \cdot {R}_{i j}} \cdot ( Δ {T}_{j} - Δ {T}_{i} ) + \frac{{F}_{i} ( t )}{{C}_{i}}$ | Equation (2) |
| If a heater is placed in room | |
| i and turned on, then, for short times | |
| $Δ {T}_{i} := \frac{{F}_{i}}{{C}_{i}} \cdot t$ | Equation (3) |
| If heat source (sink) is turned on in room j: | |
| $Δ {T}_{i} := \frac{{F}_{j}}{{C}_{i} \cdot {R}_{i j}} \cdot t$ | Equation (4) |
| This enables both C and R to be measured. | |

For each parameter region of the lumped-element model, there is a governing equation in Table 1. The mobile and fixed actuators serve as sources, F. In the equations of Table 1, if the system of rooms, i and j, reaches equilibrium with the heat sources, the equation for deviations from equilibrium are fairly simple. If one of the sources is altered, e.g., in room i, the resulting changes from equilibrium solve a simple equation because all the changes in temperature (ΔT) are initially zero. Thus, the change within a zone/room relates to the thermal mass (C), while initial changes caused by changes in neighboring rooms enable determination of the resistances (R) between elements. For example, for measured change(s) in the condition, temperature, humidity, etc. the relevant parameter, C or CR, from Equation (3) and Equation (4), can be determined. More complicated nonlinear models can be handled in a similar way. Changes in the control actuators lead to changes in the sensed variables, which are used to fit the parameters of the lumped-element model. Once the lumped-element model is determined to be accurate within a predetermined limit, the sensors and actuators can be repositioned to other locations or moved to a new building site. According to various embodiments, one or more of the sensors and actuators are configured to be repositioned to a new location within the environment prior to measuring one or more subsequent parameters of the environment.

According to various embodiments, a lumped-element model is determined to be sufficiently accurate when changes in quantified improvements of exogenous factors of the lumped-element model are less than desired control factor accuracy, or when the changes in quantified improvements of exogenous factors of the lumped-element model are less than quantifiable noise measures with one or more sensors which are determining the exogenous factors. The exogenous factors can include, e.g., weighted combination temperature, air flow, humidity, power, carbon emissions, HVAC costs, and/or other suitable exogenous factors. Thus, the HVAC control system 100 includes networked and portable devices enabled to provide enhanced model development and system identification.

According to various embodiments, in addition to changes from portable and fixed HVAC components, there are other sources of system excitation. One very useful source of system excitation is that of exogenous factors, such as, e.g., external temperature changes, humidity variations, changes in solar insolation, and wind, among other exogenous factors. Other sources of excitation, which can be used to determine the system parameters, can include, e.g., alterations to a building by actions such as, e.g., the opening and/or closing of doors, vents, curtains, windows, and/or other structures/devices, the placement and/or removal of portable walls and/or other structures, and/or other suitable sources of excitation.

According to various embodiments, examples of the types of measurements which may be made include, but are not limited to:
Measuring the integrated temperature (7) rise of one or more wall surfaces of an environment (e.g., room, wing, hall, zone, etc.) that is actively being heated and one or more neighboring environment(s) (or, e.g., room(s), wing(s), hall(s), zone(s), etc.), as well as measuring the air temperature in the environment that is being heated (it is noted that other waveforms, such as impulses, triangle ramps, etc., may be measured), and/or measuring the humidity of the room and the input air into the HVAC system.
Measuring the changes in solar light outside and within one or more rooms, along with the temperature of the room. According to various embodiments, solar light may be measured in terms of light intensity, irradiance, duration, and/or other suitable measurements of solar light. According to various embodiments, the effect of solar insolation can be determined using suitable means such as, for example, by measuring the surface temperature of a room (e.g., the average surface temperature of a room and/or a surface temperature of one or more surfaces within the room such as, e.g., furniture surfaces, skin surfaces, floor surfaces, wall surfaces, ceiling surfaces, etc.) using an IR sensor. Alternatively, a photosensor may be used to estimate the solar energy input into a room. This provides a measure of the solar load. According to various embodiments, the solar load can be measured or estimated over seasons and for different weather patterns, measuring the changes in intensity and duration of solar light that naturally occur throughout the year.
Measuring the temperature and air flow within or at the exit (exhaust) of one or more ducts that are delivering heated or cooled air to a room as a function of actuation of an HVAC unit that is the source of the duct's heated or cooled air. This provides an estimate of the cooling/heating power of the ducts.
Turning on/off fixed building HVAC and personal local HVAC components to measure and determine further system parameters.

According to various embodiments, perturbation of the system 100 could be performed at night or over weekends in order to avoid (a) inconveniencing occupants and (b) uncertainty in the data associated with variable thermal loads associated with occupants such as occupants opening/closing doors/windows, etc. It is noted, however, that perturbation may be performed at any suitable time.

Once the sensor data is collected, it is fit to the lumped-element model using typical least squares or modified objective functions. These modified objective functions include whitening (decorrelation) and discriminator-like functions (from generative adversarial networks (GANs)). When the first pass optimum parameters of the lumped-element model are obtained, the lumped-element model can be refined by the introduction or elimination of elements and reoptimization of the lumped-element model. When improvement is no longer significant, the residuals of this lumped-element model, compared with the observed behavior, can be fit with neural network models in order to account for unmodeled but predictable features in the data. Alternatively, the parameters of the lumped-element model can be fit to limited portions of the data around the current time (i.e., sliding windows so that the effective parameters such as C, R etc., become functions of time). According to various embodiments, neural network models for time series, such as recursive neural networks or long-term short term networks, can be used to fit and predict future time values of the parameters.

According to various embodiments, the preceding hybrid lumped-element (machine learning (ML)) model can be used for model-based control of the HVAC system. The control policy can be determined by traditional means and/or by reinforcement learning using new methods or some hybrid of the two.

Finally, the controls are implemented and any temporary sensors and/or environmental condition controllers are removed from the environment. The control (e.g., a control model) is updated using adaptive control to adjust the parameters of the lumped-element model, as well as neural network model parameters.

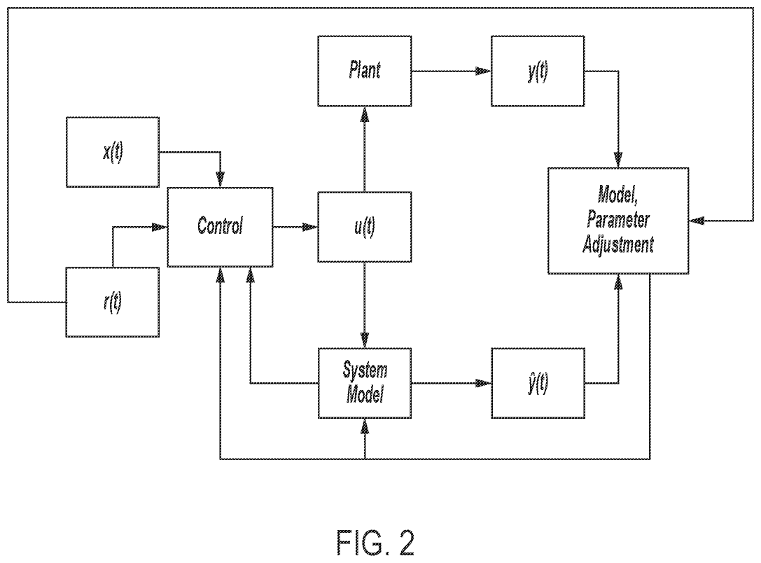

Referring now to FIG. 2, an adaptive control workflow is illustratively depicted, according to various embodiments of the present disclosure.

According to various embodiments, the desired reference state of a system, r(t), and the current state of the system, x(t), are implemented into a control model (labeled “Control”). The control model generates a control signal, u(t), which is sent to the physical system (labeled “Plant”) and the system model (labeled “System Model”). The response of the physical system, y(t), and the output from the system model, ŷ(t), are sent to a model parameter adjustment model [symbol] (labeled “Model Parameter Adjustment”) configured to adjust parameters of the lumped-element model. Further input into the model parameter adjustment model is the desired reference state of the system, r(t).

According to various embodiments, one or more of the control model, system model, and model parameter adjustment model can be white, black, or grey box models comprised of lumped-element models with parameters as well as data-based models such as, for example, machine learning models, including neural networks, trees, etc. These data-based models may also include parameters, such as, for example, weights. All the parameters of these models are adjusted in order to minimize an objective function which causes a system model prediction error to match the system model output, ŷ(t), and to reduce the likelihood of error between the reference state, r(t), and the system response, y(t). In this way, the control model adapts to changes in the HVAC system, environmental changes, and building use patterns. For example, based on the measured and analyzed parameters measured by the sensors, an adapted lumped-element model is generated. The adaptive control, based on this adapted lumped-element model, can make changes to the HVAC system. For example, if the adapted lumped-element model determines that a temperature change is needed within the environment, the adaptive control can cause the heating devices and/or air conditioning devices of the HVAC system to be adjusted in their relative intensities or powered on/off, causing an increase and/or decrease in temperature within the environment. Similarly, based on changes needed within the environment according to the adapted lumped-element model, the adaptive control can make other suitable changes to the HVAC system such as, e.g., adjusting ventilation (e.g., by adjusting fan speed, opening and shutting vents, etc.) within the environment, adjusting the light within the environment (e.g., by adjusting the positions of drapes, blinds, etc.) and/or by adjusting any other suitable components of the HVAC system.

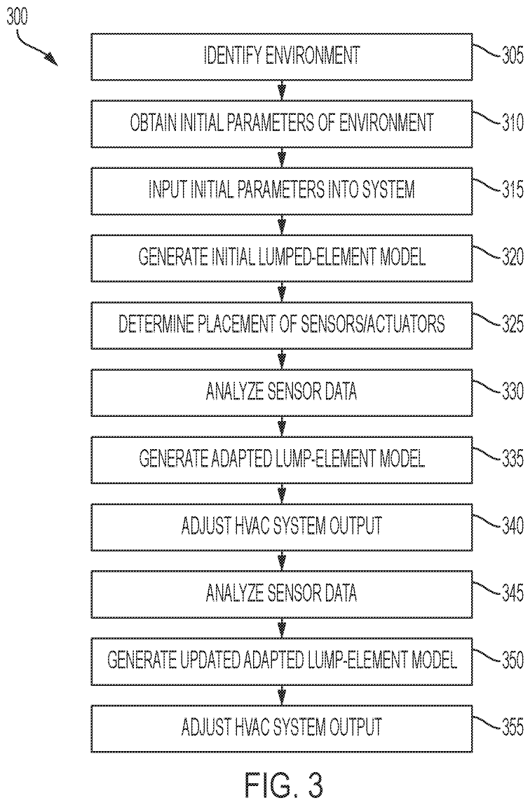

Referring now to FIG. 3, a flowchart of a method 300 for controlling an HVAC system is illustratively depicted.

At 305, an environment is identified. The environment may include, for example, a building, a room, a hall, and/or other suitable environments over which the HVAC system can control. According to various embodiments, the environment may be a single zone or may be separated into two or more zones over which the HVAC system can control. At 310, initial parameters of the environment are obtained. These initial parameters can be obtained via any suitable means such as, but not limited to, blueprint analyzation, robot simultaneous localization and mapping (SLAM), environment walkthrough, previous system documentation, IR imaging, and/or other suitable means. These initial parameters are, at 315, input into the HVAC control system via, e.g., a user interface of a computing device, direct uploading from one or more sensing devices, and/or other suitable means.

Based on the initial parameters, an initial lumped-element model of the environment is generated, at 320. On the basis of the initial lumped-element model, placement of one or more sensors and environmental condition controllers is determined, at 325. According to various embodiments, the one or more sensors and/or environmental condition controllers are placed during the environment walkthrough. The one or more sensors and environmental condition controllers are placed at locations such as, e.g., locations where actuators such as vents, fans, or windows are placed, as well as regions where the environmental conditions are to be controlled. For example, if a control area is a part of a room where occupants reside, a sensor may be placed appropriately to sense relevant conditions. If the area has the means to change the conditions, it is usually much more useful to have it as a control region rather than if there are no direct means for change.

The one or more sensors and environmental condition controllers form a network of interconnected sensors and environmental condition controllers. According to some embodiments, one or more of the sensors and/or environmental condition controllers are temporarily positioned within the environment. According to some embodiments, some of the one or more sensors and/or environmental condition controllers are permanently placed/fixed within the environment. According to various embodiments, the one or more sensors are in electronic communication with one or more processors of the HVAC control system.

At 330, data pertaining to the environment is taken from the one or more sensors and analyzed. According to various embodiments, the data is input into the model parameter adjustment model to reduce or minimize the difference between unmodeled but predictable features in the data and the system response as well as reduce or minimize the difference between the system response and the desired reference state of the system.

At 335, the initial lumped-element model is fit to the analyzed data, generating an adapted lumped-element model. At 340, based on the adapted lumped-element model, an output of one or more sources of temperature-controlled and/or humidity-controlled air is generated/operated. The sources of temperature-controlled and humidity-controlled air may include, for example, but not limited to, an air conditioner, a fan, a heater, and/or any other suitable sources of temperature-controlled air. For example, the environmental condition controllers, based on the adapted lumped-element model, can adjust the temperature of the environment by causing, via one or more actuators, the heating devices and/or air conditioning devices of the HVAC system to be adjusted in their relative intensities or powered on/off. Similarly, based on changes needed within the environment according to the adapted lumped-element model, the environmental condition controllers can make other suitable changes to the HVAC system such as, e.g., adjusting ventilation (e.g., by adjusting fan speed, opening and closing vents, etc.) within the environment, adjusting the light within the environment (e.g., by adjusting the position of drapes, blinds, etc.) and/or by adjusting any other suitable components of the HVAC system According to various embodiments, the lumped-element models consist of simple first order differential equation models for comfort variables for the various control regions with their interactions. The comfort variables include, for example, temperature, humidity, air flow, and/or other variables affecting occupant comfort.

According to various embodiments, once the HVAC system has been adjusted in accordance with the adapted lumped-element model, parameter measurements, at 345, are again taken from the sensors and analyzed. At 350, the adapted lumped-element model is fit to the newly analyzed data from the sensors, generating an updated adapted lumped-element model and, at 355, based on the updated adapted lumped-element model, an output of one or more sources of temperature-controlled air is generated, similar to above. This process is repeated, as necessary, enabling the system to dynamically update the lumped-element model as parameters within the environment, and the properties of the HVAC system, change.

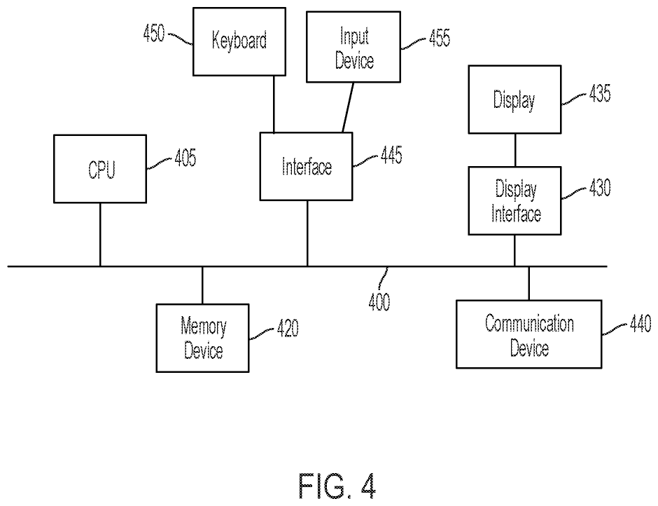

FIG. 4 depicts a block diagram of hardware that may be used to contain or implement program instructions, such as those of a cloud-based server, electronic device, virtual machine, or container. A bus 400 serves as an information highway interconnecting the other illustrated components of the hardware. The bus may be a physical connection between components of the system, or a wired or wireless communication system via which various components of the system share data. Processor 405 is a processing device that performs calculations and logic operations required to execute a program. Processor 405, alone or in conjunction with one or more of the other components disclosed in FIG. 4, is an example of a processing device, computing device or processor as such terms are used within this disclosure (e.g., computing device 105 of FIG. 1). The processing device may be a physical processing device, a virtual device contained within another processing device, or a container included within a processing device.

A memory device 420 is a hardware component or segment of a hardware component on which programming instructions, data, or both may be stored. Read only memory (ROM) and random access memory (RAM) constitute examples of memory devices, along with cloud storage services.

An optional display interface 430 may permit information to be displayed on the display 435 in audio, visual, graphic or alphanumeric format. Communication with external devices may occur using various communication devices 440, such as a communication port or antenna. A communication device 440 may be communicatively connected to a communication network, such as the Internet or an intranet.

The hardware may also include a user input interface 445 which allows for receipt of data from input devices such as a keyboard or keypad 450, or other input device 455 such as a mouse, a touch pad, a touch screen, a remote control, a pointing device, a video input device and/or a microphone. Data also may be received from an image capturing device 410 such as a digital camera or video camera.

In this document, “electronic communication” refers to the transmission of data via one or more signals between two or more electronic devices, whether through a wired or wireless network, and whether directly or indirectly via one or more intermediary devices. Devices are “communicatively connected” if the devices are able to send and/or receive data via electronic communication.

A “computer,” “computing device,” or “electronic device” refers to a device that includes a processor and non-transitory, computer-readable memory. The memory may contain program instructions that, when executed by the processor, cause the computing device to perform one or more operations according to the program instructions. Examples of computing devices include personal computers, servers, mainframes, gaming systems, televisions, kitchen appliances, and portable electronic devices such as smartphones, smart watches, wearable electronic devices, digital cameras, fitness tracking devices, tablet computers, laptop computers, media players and the like.

The features and functions described above, as well as alternatives, may be combined into many other different systems or applications. Various alternatives, modifications, variations or improvements may be made by those skilled in the art, each of which is also intended to be encompassed by the disclosed embodiments.

1. A heating, ventilation, and air conditioning (HVAC) control system, comprising:
one or more sources of controlled air;
a network of portable sensors that are configured to measure one or more parameters of an environment;
one or more environmental condition controllers that are configured to operate the one or more sources of controlled air; and
a computing device, including a processor and memory, wherein the memory stores programming instructions that are configured to, when executed, cause the processor to:
generate an initial lumped-element model of the environment,
update the initial lumped-element model using the one or more parameters of the environment to generate an adapted lumped-element model of the environment, and
cause the one or more environmental condition controllers to adjust an output of the one or more sources of controlled air based on the adapted lumped-element model.

2. The HVAC control system of claim 1, wherein one or more of the portable sensors are configured to be repositioned to a new location within the environment prior to measuring one or more subsequent parameters of the environment.

3. The HVAC control system of claim 2, wherein the programming instructions are configured to further cause the processor to update the adapted lumped-element model using the one or more subsequent parameters of the environment to generate an updated adapted lumped-element model of the environment.

4. The HVAC control system of claim 1, wherein the portable sensors include one or more of the following:
air temperature measurement sensors;
humidity sensors;
surface temperature measurements;
infrared remote surface measurement sensors;
air flow measurement sensors;
light sensors; or
sensors for generating geometric measurements.

5. The HVAC control system of claim 1, wherein one or more of the portable sensors are positioned outside the environment.

6. The HVAC control system of claim 1, wherein the environment includes one or more of a building or one or more rooms within the building.

7. The HVAC control system of claim 1, wherein adjusting the output includes increasing or decreasing a temperature of the environment.

8. The HVAC control system of claim 1, wherein adjusting the output includes adjusting a humidity of the environment.

9. The HVAC control system of claim 1, wherein the computing device further includes a user interface configured to receive one or more initial parameters of the environment.

10. The HVAC control system of claim 9, wherein the programming instructions are configured to further cause the processor to generate the initial lumped-element model based on the one or more initial parameters of the environment.

11. A method for controlling a heating, ventilation, and air conditioning (HVAC) system, comprising:
generating, using a processor of a computing device, an initial lumped-element model of an environment;
positioning portable sensors relative to the environment, the portable sensors being in a network of sensors;
measuring, using the portable sensors, one or more parameters of an environment;
updating the initial lumped-element model using the one or more parameters of the environment, generating an adapted lumped-element model of the environment; and
adjusting, using one or more environmental condition controllers, an output of one or more sources of controlled air based on the adapted lumped-element model,
wherein the one or more environmental condition controllers are configured to operate the one or more sources of controlled air.

12. The method of claim 11, further comprising:
repositioning one or more of the portable sensors to a new location relative to the environment; and
measuring one or more subsequent parameters of the environment using the repositioned portable sensors.

13. The method of claim 12, further comprising updating the adapted lumped-element model using the one or more subsequent parameters of the environment, generating an updated adapted lumped-element model of the environment.

14. The method of claim 11, wherein one or more of the portable sensors are positioned outside the environment.

15. The method of claim 11, wherein adjusting the output includes increasing or decreasing a temperature of the environment.

16. The method of claim 11, wherein the computing device includes a user interface configured to receive one or more initial parameters of the environment, and further comprising:
inputting the one or more initial parameters of the environment into the computing device via the user interface.

17. The method of claim 16, wherein the initial lumped-element model is based on the one or more initial parameters of the environment.

18. A computer-readable medium comprising programming instructions that are configured to cause a processor to:
generate an initial lumped-element model of an environment;
update the initial lumped-element model using one or more parameters of the environment, generating an adapted lumped-element model of the environment, wherein the one or more parameters are measured using portable sensors in a network of sensors positioned relative to the environment; and
adjust, using one or more environmental condition controllers, an output of one or more sources of controlled air based on the adapted lumped-element model, wherein the one or more environmental condition controllers are configured to operate the one or more sources of controlled air.

19. The computer-readable medium of claim 18, wherein:
the portable sensors are configured to be repositioned to a new location relative to the environment and measure one or more subsequent parameters of the environment at the new location, and
the programming instructions are further configured to cause the processor to update the adapted lumped-element model using the one or more subsequent parameters of the environment, generating an updated adapted lumped-element model of the environment.

20. The computer-readable medium of claim 18, wherein the initial lumped-element model is based on one or more initial parameters of the environment.
